(19) United States
(12) Patent Application Publication
(10) Pub. No.: US 2011/0151709 A1
(43) Pub. Date: Jun. 23, 2011

(54) CABLE, CABLE CONNECTOR AND CABLE ASSEMBLY

(76) Inventor: Ho KIM, Seoul (KR)

(21) Appl. No.: 12/975,669

(22) Filed: Dec. 22, 2010

(30) Foreign Application Priority Data
Dec. 23, 2009 (KR) 10-2009-0129672
Mar. 23, 2010 (KR) 10-2010-0025715

(51) Int. Cl. H01R 12/70; H02G 3/00

(52) U.S. Cl. 439/492; 174/70 R

(57) ABSTRACT

A cable which is provided so as to surround an outer surface of a conductor by an insulator, which is planar and which is divided into one surface and the other surface, includes a first terminal portion that is formed by at least a portion of the conductor being exposed to the one surface, and a second terminal portion that is extended from the first terminal portion and is formed by at least a portion of the conductor being exposed to the other surface. A cable connector according to another embodiment comprises a plurality of contact protrusions where come into contact with a planar cable, and at least one of the contact protrusions has a protruding length different from a protruding length of one of other contact protrusions. Accordingly, it is possible to notably reduce a possibility of poor connection.

### BACKGROUND

1. Field

This document relates to a cable, a cable connector, and a cable assembly including the same.

2. Related Art

Various kinds of electronic devices including computers, portable terminals, or the like are increasing their ranges used. The electronic devices may include printed circuit boards (PCB) in which electronic circuits are integrated.

A cable is used to connect the printed circuit board to the electronic device. In addition, for electrical connection between the printed circuit board and the cable, a cable connector is used.

A cable connector in the related art has a problem in that when there are foreign materials on a surface of a terminal portion of the cable, or the terminal is oxidized, an electric signal is not properly transmitted to a contact protrusion of the cable connector which comes into contact with the terminal portion of the cable.

### SUMMARY

Embodiments of the invention provide a cable, a cable connector, and a cable assembly, capable of notably reducing a possibility of poor connection.

According to an exemplary embodiment of the invention, there is provided a cable which is provided so as to surround an outer surface of a conductor by an insulator, which is planar and which is divided into one surface and the other surface, including a first terminal portion that is formed by at least a portion of the conductor being exposed to the one surface; and a second terminal portion that is extended from the first terminal portion and is formed by at least a portion of the conductor being exposed to the other surface.

The cable may further include a plate-shaped supplementary plate between the first terminal portion and the second terminal portion.

The second terminal portion may be formed by bending the first terminal portion and be formed by bending the first terminal portion twice substantially by 90 degrees at one time.

The first and second terminal portions may be provided at both ends of the cable.

According to an exemplary embodiment of the invention, there is provided a cable connector coupled to a planar cable which is provided so as to surround an outer surface of a conductor by an insulator and which is divided into one surface and the other surface, including at least one first contact portion that comes into contact with a first terminal portion provided in one surface of the cable and enables electricity to be flowed; and at least one second contact portion that comes into contact with a second terminal portion provided in the other surface of the cable and enables electricity to be flowed.

According to another exemplary embodiment of the invention, there is provided a cable connector comprising a terminal of which one side is electrically connected to a board and the other side is electrically connected to a terminal portion of a cable, wherein the terminal includes a plurality of contact protrusions where are extended from the terminal and come into contact with the cable, and wherein at least one of the contact protrusions has a protruding length different from a protruding length of one of other contact protrusions.

The plurality of contact protrusions may include at least three contact protrusions which are provided spaced apart from each other, and contact protrusions positioned at outside may be shorter than at least one of contact protrusions positioned at inside.

The terminal may include a contact point portion that comes into contact with one surface of the cable and where the contact protrusions are positioned; and a support portion that comes into contact with the other surface of the cable and prevents the cable inserted into the terminal from being moved. The support portion may be provided with one or more contact protrusions. The contact protrusions of the support portion may be positioned symmetrically with the contact protrusions of the contact point portion, or at least one or all of the contact protrusions of the support portion may be positioned to be misaligned with the contact protrusions of the contact point portion.

According to an exemplary embodiment of the invention, there is provided a cable assembly including a planar cable that is provided so as to surround an outer surface of a conductor by an insulator and is divided into one surface and the other surface; and a cable connector that has a plurality of contact protrusions electrically connected to the exposed conductor of the cable, wherein the plurality of contact protrusions has three or more contact protrusions which are spaced apart from each other, and contact protrusions positioned at outside are shorter than at least one of contact protrusions positioned at inside.

The cable may include a first terminal portion that is formed by at least a portion of the conductor being exposed to the one surface; and a second terminal portion that is extended from the first terminal portion and is formed by at least a portion of the conductor being exposed to the other surface, and the connector may include one or more contact protrusions that come into contact with the first terminal portion; and one or more contact protrusions that come into contact with the second terminal portion.

The cable may further include a plate-shaped supplementary plate between the first terminal portion and the second terminal portion.

The contact protrusions coming into contact with the first terminal portion may be positioned symmetrically with the contact protrusions coming into contact with the second terminal portion, or at least one or all of the contact protrusions coming into contact with the first terminal portion may be positioned to be misaligned with the contact protrusions coming into contact with the second terminal portion.

Therefore, it is possible to notably reduce a possibility of poor connection and stably transmit an electric signal.

### BRIEF DESCRIPTION OF THE DRAWINGS

FIG. 1 is a perspective view of a cable according to an embodiment of the invention;

FIGS. 2 to 4 are diagrams illustrating manufacturing steps of the cable in FIG. 1;

FIG. 5 is a perspective view of a cable connector according to an embodiment of the invention;

FIG. 6 is a sectional view taken along the line I-I in FIG. 5;

FIG. 7 is a sectional view of a cable connector which connects a cable to a board, according to another embodiment;

FIG. 8 is a sectional view of a terminal which is a portion of the cable connector according to another embodiment of the invention;

FIG. 9 is a sectional view illustrating a preferable connection example between the cable and the cable connector according to another embodiment of the invention;

FIG. 10 is a sectional view illustrating a preferable connection example between the cable and the cable connector according to another embodiment of the invention;

FIG. 11 is a sectional view illustrating a state where the cable according to the embodiment shown in FIG. 1 is coupled to a terminal of the cable connector according to the modification shown in FIGS. 7; and

FIG. 12 is a perspective view of a cable assembly according to another embodiment of the invention.

### DETAILED DESCRIPTION

These and other objects of the present application will become more readily apparent from the detailed description given hereinafter. The present invention can be variously changed and has several embodiments and thereinafter, a specific embodiment is described in detail with reference to the drawings. Like reference numerals designate like elements throughout the specification. Detailed descriptions of well-known functions and structures incorporated herein may be omitted to avoid obscuring the subject matter of the present invention. Further, numerals (e.g., a first and a second) used in a process of describing the present application are identification symbols for identifying one constituent element from other constituent elements.

Hereinafter, embodiments of the present invention are described in detail with reference to the accompanying drawings. The suffixes ‘module’, ‘unit’, and ‘part’ may be used for elements in order to facilitate the disclosure. Significant meanings or roles may not be given to the suffixes themselves and it is understood that the module', ‘unit’, and ‘part’ may be used together or interchangeably.

FIG. 1 is a perspective view according to an embodiment of the invention.

As shown in FIG. 1, a cable 10 according to an embodiment of the invention include a cable body 12 applied with insulators, and terminal portions 14 provided at both ends of the cable body 12.

The cable 10 may be an FPC (flexible printed circuit) or an FFC (flexible flat cable) which electrically connects two objects to each other, which are physically spaced apart from each other. The cable 10 may be formed by applying nonconductors on conductors. For example, there is a case where rubber which is a nonconductor is applied on copper which is a conductor. Therefore, both ends of the cable 10 expose the conductor, and electricity may be flowed via the exposed conductor at both the ends.

The cable body 12 substantially forms a portion of the cable 10. In the cable body 12, conductors may not be exposed to outside but covered with nonconductors. The cable body 12 may have a planar shape. In other words, respective copper lines which are conductors are arranged in parallel with a little space, and rubber or plastic which is a nonconductor is applied thereon, thereby forming the cable body 12. Thus, a direction in which the copper lines which are conductors are arranged is a length direction of the cable body 12, and a direction perpendicular to the length direction is a width direction of the cable body 12. The cable, used to electrically connect two points spaced apart from each other, has a longer shape in the length direction more than in the width direction. Further, the cable body 12 has a flat plate shape. In the following, thus, for better understanding, the flat plate-shaped cable body 12 is described divided into one surface and the other surface. One surface and the other surface means, for example, a flat upper surface of the cable body 12 and a flat lower surface thereof.

The terminal portions 14 are ends of the cable body 12. The terminal portions 14 are parts where only the conductors are exposed of the conductors and nonconductors forming the cable body 12. Since the terminal portions 14 are provided only at both the ends of the cable body 12, an electric signal can be transmitted via only the terminal portions 14 even if the cable 10 comes into contact with other conductors on the way. The terminal portions 14 may be formed by removing nonconductors from the cable body 12 or by not applying nonconductors only on parts of the terminal portions 14 when the cable body 12 is initially formed. As described above, the terminal portions 14 function as a path which transmits an electric signal transmitted from one side to the other side. Thus, correct contact of the terminal portions 14 enables an electric signal to be smoothly transmitted.

Each of the terminal portions 14 according to an embodiment of the invention includes first and second terminal portions 16 and 17, and a supplementary plate 19 provided between the first and second terminal portions 16 and 17 such that electrical connection can be smoothly made.

The first terminal portion 16 is a part where the conductors forming the cable body 12 are exposed to one side. That is to say, in the enlarged view shown in FIG. 1, the first terminal portion 16 indicates a part exposed upwardly. The first terminal portion 16 is provided in which the conductors are exposed to one side, and thereby electric connection is enabled in the one side direction.

The second terminal portion 17 is a part where the conductors forming the cable body 12 are exposed to the other side. That is to say, in the enlarged view shown in FIG. 1, the second terminal portion 17 indicates a part exposed downwardly. The second terminal portion 17 is provided in which the conductors are exposed to the other side, and thereby electric connection is enabled in the other side direction. The second terminal portion 17 may be extended from the first terminal 16. In addition, the second terminal portion 17 may be provided by bending the first terminal portion 16 twice in the same direction, and the bent angle may be respectively 90 degrees. In other words, the second terminal portion 17 may be provided substantially in parallel to the first terminal 16.

The first and second terminal portions 16 and 17 are provided in one side and the other side directions, and thereby electric connection is enabled in two directions at the same time. Thus, even when electric connection to either the first terminal portion 16 or the second terminal portion 17 is poor, electric connection to another terminal is enabled. For example, a possibility that foreign materials such as dusts are stacked is greater in the first terminal portion 16 positioned at the upper side than in the second terminal portion 17 positioned at the lower side. Therefore, when foreign materials are stacked on the first terminal 16, electric connection to the first terminal portion 16 may not be smoothly made. Even in this case, electric connection to the second terminal portion 17 can be maintained. Thereby, it is possible to reliably maintain the electric connection as compared with when any one of the first and second terminal portions 16 and 17 is provided.

The supplementary plate 19 may be inserted between the first and second terminal portions 16 and 17. The supplementary plate 19 makes the first and second terminal portions 16 and 17 have a flat shape, and maintains a thickness from the first terminal portion 16 to the second terminal portion 17 via the supplementary plate 19 to be constant. For example, if a case where only the first and second terminal portions 16 and 17 are configured without the supplementary plate 19 is thought, the conductors forming the first and second terminal portions 16 and 17 are relatively thin copper lines, and thus the thickness formed only by the first and second terminal portions 16 and 17 may be thinner than a certain degree. In this case, if the first and second terminal portions 16 and 17 are inserted into a connector for coupling, a nipping force with the inserted part is weak, and thereby the coupling may be easily loosened. The supplementary plate 19 may have a plate shape with a constant thickness. Therefore, by appropriately adjusting the thickness of the supplementary plate 19, it is possible to adjust an entire thickness of the supplementary plate 19 and the first and second terminal portions 16 and 17 which are coupled to upper and lower sides of the supplementary plate 19, to a desired degree.

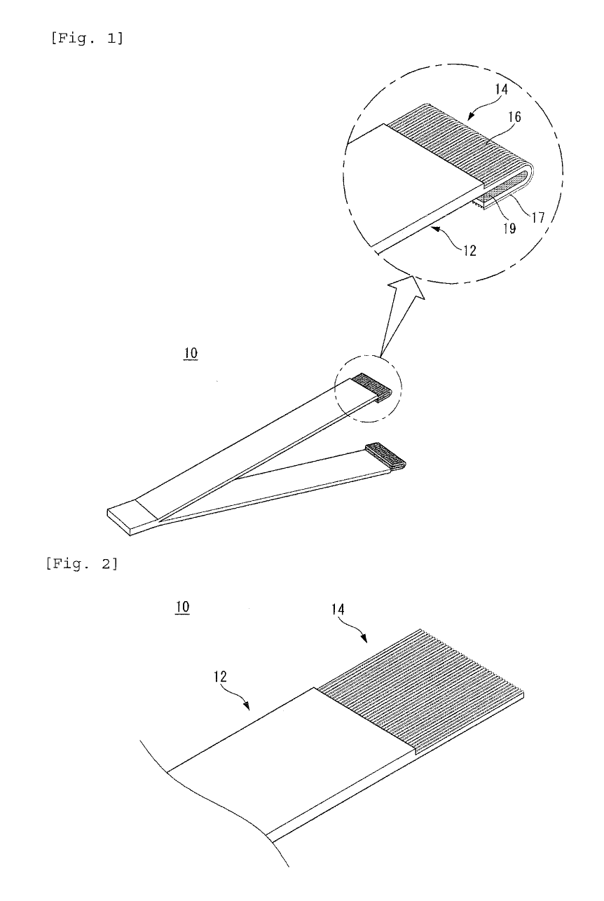

FIGS. 2 to 4 are diagrams illustrating manufacturing steps of the cable shown in FIG. 1.

As shown in FIG. 2, the cable 10 includes the cable body 12, and the terminal portion 14 provided at the end of the cable body 12. The cable body 12 may be formed by applying nonconductors on conductors as described above. The terminal portion 14 may be formed by removing nonconductors from the cable body 12 or by not applying nonconductors only on a part of the terminal portion 14 when the cable body 12 is formed.

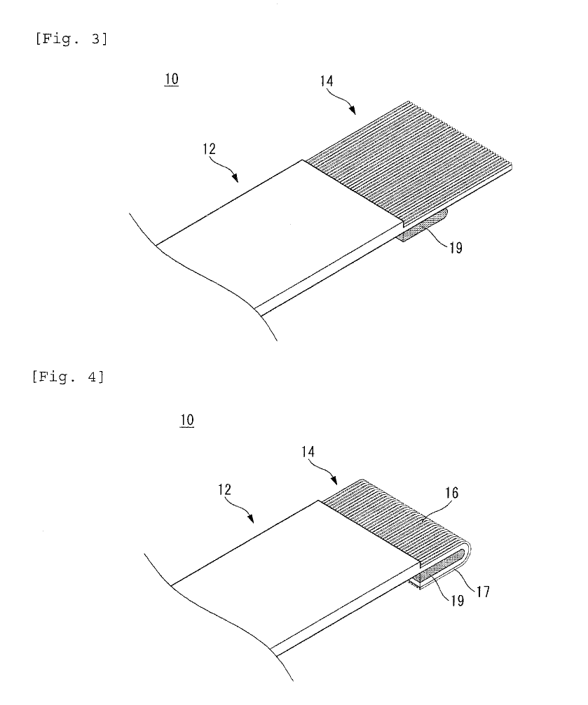

As shown in FIG. 3, the supplementary plate 19 is attached to a certain point of the terminal portion 14. The supplementary plate 19 may be made of rubber or plastic which is flat and has constant thickness and strength. The supplementary plate 19 enables the terminal portion 14 formed of conductors of which coating is removed, to have a constant shape.

As shown in FIG. 4, the terminal portion 14 may be attached along the supplementary plate 19 attached to the certain point of the terminal portion 14. This means that terminal portion 14 is bent twice by 90 degrees in one direction to thereby be attached to the supplementary plate 19. The terminal portion 14 is attached to the supplementary plate 19 through the bending twice, thereby forming the first terminal portion 16 and the second terminal portion 17.

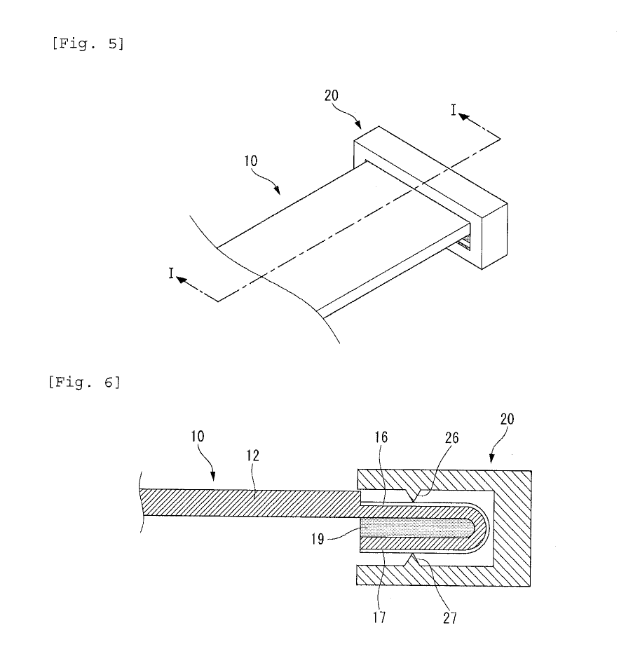

FIG. 5 is a perspective view of a cable connector according to an embodiment of the invention.

As shown in FIG. 5, a cable connector 20 according to an embodiment of the invention is coupled to the end of the cable 10. When the cable 10 is coupled to the cable connector 20, electricity is flowed via the cable 10.

FIG. 6 is a sectional view taken along the line I-I in FIG. 5.

As shown in FIG. 6, the cable 10 and the cable connector 20 are electrically connected to each other via first and second contact protrusions 26 and 27.

The first and second contact protrusions 26 and 27 are extended from the cable connector 20. All or a portion of the first and second contact protrusions 26 and 27 may be a conductor. An electric signal transmitted via the cable 10 is transmitted to the cable connector 20 via the first and second contact protrusions 26 and 27. The first and second contact protrusions 26 and 27 respectively come into contact with the first and second terminal portions 16 and 17. The upper first contact protrusion 26 comes into contact with the first terminal portion 16, and the lower second contact protrusion 27 comes into contact with the second terminal portion 17. The first and second terminal portions 16 and 17 formed through the bending of the conductors are provided so as to come into contact with the first and second contact protrusions 26 and 27, respectively, and thereby it is possible to considerably decrease a possibility of poor contact. The supplementary plate 19 is provided so as to provide constant thickness and strength between the first and second terminal portions and 17, and thereby it is possible to decrease a possibility that the cable 10 is decoupled from the cable connector 20.

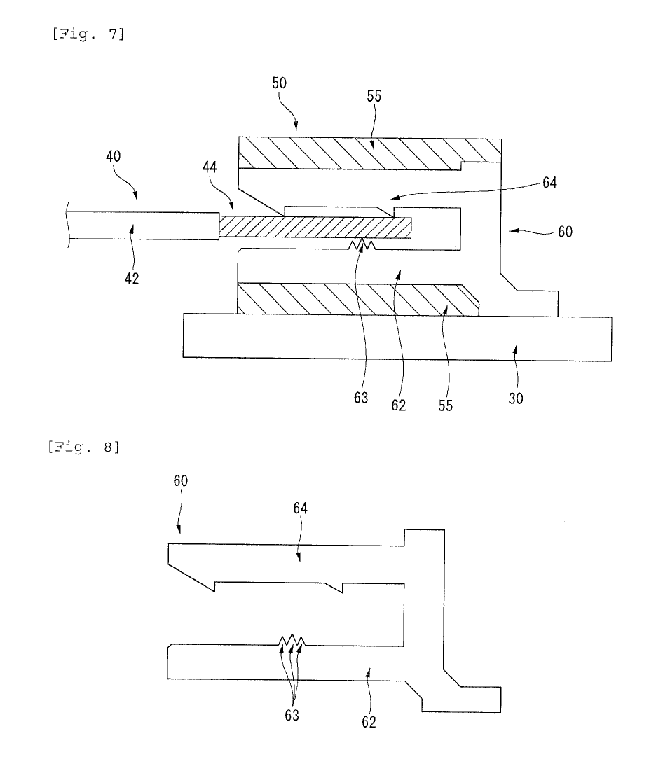

FIG. 7 is a sectional view illustrating a cable connector which connects a cable to a board according to another embodiment of the invention.

As shown in FIG. 7, a cable connector 50 according to an embodiment of the invention is used to electrically connect a board 30 to a cable 40.

The board 30 is a printed circuit board (PCB) on which wires are integrated and various elements are mounted, and which electrically connects the elements to each other. Various kinds of PCBs such as a ram, a main board, a LAN card are produced.

The cable 40 includes a cable body 42 applied with insulators, and a terminal portion 44 provided at each end of the cable body 42.

A housing 55 forms an exterior of the connector 50. The housing 55 may be provided with an adhesion means (not shown) which prevents the cable from being freely released from the housing 55 in a state where they are coupled to each other.

A terminal 60 is installed in the housing 55. The terminal 60 is generally made of a metal conductor, and is installed in plurality in parallel so as to transmits plural signals at the same time. The terminal 60 has one side positioned inside the housing 55 and the other side exposed to an outside of the housing 55.

The terminal 60 has a contact point portion 62 which is electrically connected to the terminal portion 44 of the cable 60. The number of the terminal portion 44 of the cable 60 is the same as the number of the terminal 60. Contact protrusions 63 which directly come into contact with the terminal portion 44 of the cable 40 are provided in an edge of the contact point portion 62.

A support portion 64 is formed in the same direction in parallel to the contact point portion 62 with a predetermined interval. The support portion 64 prevents the cable inserted into the terminal 60 from being swung. For this purpose, the terminal portion 44 is supported in a state of being hung on one side of the housing 55, or an adhesion means such as an actuator may be further provided.

FIG. 8 is an enlarged sectional view of the terminal which a portion of the cable connector according to another embodiment of the invention.

The contact protrusions 63 of the terminal 60 of the cable connector 50 coming into contact with the terminal portion 44 of the cable 40 are provided in plurality, and any one of the contact protrusions 63 has a different protruding length from at least another contact protrusion.

For example, as shown in FIG. 8, the contact point portion 62 of the terminal 60 has three contact protrusions 63. The protruding length of the contact protrusion 63 positioned at the center is larger than those of the contact protrusions 63 positioned at both sides thereof, and thereby the contact protrusions 63 of the terminal 60 are electrically well connected to the terminal portion 44 of the cable 40 regardless of the coupling state of the cable 40. The contact point portion 62 may have two or more contact protrusions 63.

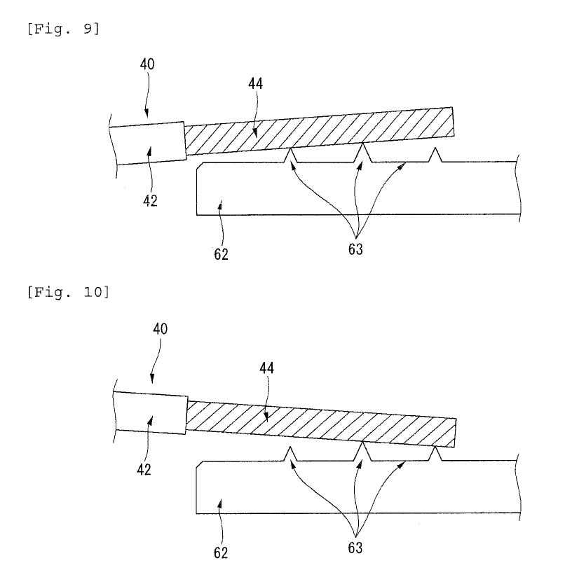

FIGS. 9 and 10 are enlarged sectional views illustrating preferable connection examples between the cable and the cable connector according to another embodiment of the invention.

In FIGS. 9 and 10, the contact point portion 62 has three contact protrusions 63. Of course, two contact protrusions 63 or three or more contact protrusions 63 may be provided. Since the contact protrusion positioned at the center is relatively long, even when the cable 40 is not coupled to the contact point portion 62 in parallel, at least two contact protrusions 63 come into contact with the terminal portion 44 of the cable 40.

As shown in FIG. 9, even when the end of the terminal portion 44 of the cable 40 is coupled leaning towards the support portion 64 of the connector 60, at least two contact protrusions 63 come into contact with the terminal 44 of the cable 40.

In the same manner, as shown in FIG. 10, even when the end of the terminal portion 44 of the cable 40 is coupled leaning towards the contact point portion 62 of the connector 60, at least two contact protrusions 63 come into contact with the terminal 44 of the cable 40.

Therefore, when the contact protrusions 63 provided in the contact point portion 62 have different lengths, a possibility that contact points occur between the terminal portion 44 of the cable 40 and the contact protrusions 63 of the contact point portion 62 can be increased irrespective of coupling conditions of the cable 40.

Particularly, when at least three or more contact protrusions 63 are provided, two or more contact protrusions 63 are connected to the terminal portion 44 of the cable 40 at all time. Accordingly, even when any one contact protrusion 63 is covered by foreign materials, the other contact protrusions 63 are electrically connected to the terminal portion 44 of the cable 40.

As the number of the contact protrusions 63 increases, contact capability between the cable connector 50 and the cable 40 is improved.

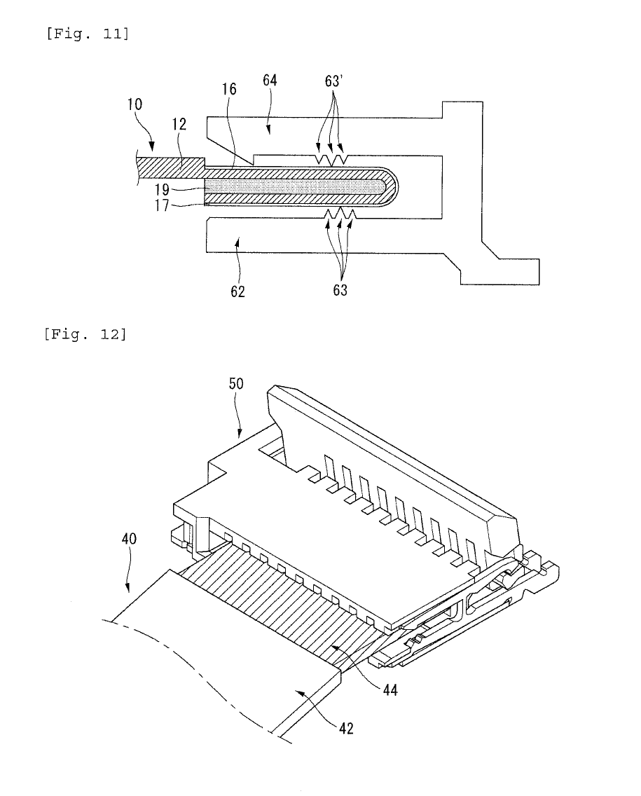

FIG. 11 is a sectional view illustrating coupling between the cable according to the embodiment shown in FIG. 1 and the cable connector according to the modification shown in FIG. 7.

One side of the terminal 60 is constituted by the support portion 64 for preventing the contact point portion from being moved, however, the support portion 64 may function as a second contact point portion by providing contact protrusions 63′ electrically connected to the terminal portion 44 of the cable 40 in the support portion 64.

The terminal portion 44 of the cable 40 is typically formed on only one surface, however, when the terminal portion is formed on the other surface like the embodiment shown in FIG. 1, the support portion 64 functions as the second contact point portion and thus it is possible to make preparations for a case where the contact point portion 62 of the cable connector 50 is poorly connected.

The contact protrusions 63′ provided in the support portion 64 may be provided in plurality, and only one contact protrusion 63′ may be provided unlike the contact protrusions 63. The contact protrusions 63′ of the support portion 64 may be symmetrically provided at a position facing the contact protrusions 63 of the contact point portion 62. A portion of the contact protrusions 63′ of the support portion 64 may be positioned symmetrically with the contact protrusions 63 of the contact point portion 62 and the remaining contact protrusions 63′ may be positioned misaligned with the contact protrusions 63 of the contact point portion 62. The contact protrusions 63′ of the support portion 64 may be all positioned misaligned with the contact point portion 62.

The contact protrusions 63′ provided in the support portion 64 notably decreases a possibility of poor connection between the cable 40 and the cable connector 50.

FIG. 12 is a perspective view of a cable assembly according to an embodiment of the invention.

As shown in FIG. 12, the cable connector 50 according to another embodiment of the invention is connected to an end of the cable 40. Each terminal portion 44 of the cable 40 comes into contact with the contact protrusions 63 of the contact point portion 62 of each cable connector 50. If the cable 40 is coupled to the cable connector 50, electricity can be flowed via the cable 40.

The terminal 60 according to an embodiment of the invention configured as described above is installed in each of terminal installing grooves provided in one line in the housing 55 which constitutes a portion of the cable connector 50. The configuration of the housing 55 and the terminal 60 of the cable connector 50 is the same as that of a typical cable connector except for modification due to the structural improvement according to the invention.

The planar cable 40 in which the insulator surrounds the outer surface of the conductor and a portion of the conductor is exposed and which can be divided into one surface and the other surface, is connected to the cable connector 50 provided with a plurality of contact protrusions which are electrically connected to the exposed conductor of the cable. At least three or more contact protrusions are provided spaced apart from each other, and the contact protrusions positioned at the outside are shorter than the contact protrusion positioned at the inside. Thereby, a possibility of poor connection in the cable assembly shown in FIG. 12 is far lower than in the related art.

Although embodiments of the present invention have been described in detail hereinabove, it should be clearly understood that many variations and modifications of the basic inventive concepts herein described, which may appear to those skilled in the art, will still fall within the spirit and scope of the embodiments of the present invention as defined in the appended claims.

What is claimed is:

1. A cable which is provided so as to surround an outer surface of a conductor by an insulator, which is planar and which is divided into one surface and the other surface, comprising:
a first terminal portion that is formed by at least a portion of the conductor being exposed to the one surface; and
a second terminal portion that is extended from the first terminal portion and is formed by at least a portion of the conductor being exposed to the other surface.

2. The cable of claim 1, further comprising a plate-shaped supplementary plate between the first terminal portion and the second terminal portion.

3. The cable of claim 1, wherein the second terminal portion is formed by bending the first terminal portion.

4. The cable of claim 3, wherein the second terminal portion is formed by bending the first terminal portion twice substantially by 90 degrees at one time.

5. The cable of claim 1, wherein the first and second terminal portions are provided at both ends of the cable.

6. A cable connector coupled to a planar cable which is provided so as to surround an outer surface of a conductor by an insulator and which is divided into one surface and the other surface, comprising:
at least one first contact portion that comes into contact with a first terminal portion provided in one surface of the cable and enables electricity to be flowed; and
at least one second contact portion that comes into contact with a second terminal portion provided in the other surface of the cable and enables electricity to be flowed.

7. A cable connector comprising a terminal of which one side is electrically connected to a board and the other side is electrically connected to a terminal portion of a cable,
wherein the terminal includes a plurality of contact protrusions where are extended from the terminal and come into contact with the cable, and
wherein at least one of the contact protrusions has a protruding length different from a protruding length of one of other contact protrusions.

8. The cable connector claim 7, wherein the plurality of contact protrusions comprise at least three contact protrusions which are provided spaced apart from each other, and
wherein contact protrusions positioned at outside are shorter than at least one of contact protrusions positioned at inside.

9. The cable connector of claim 7, wherein the terminal includes:
a contact point portion that comes into contact with one surface of the cable and where the contact protrusions are positioned; and
a support portion that comes into contact with the other surface of the cable and prevents the cable inserted into the terminal from being moved.

10. The cable connector of claim 9, wherein the support portion is provided with one or more contact protrusions.

11. The cable connector of claim 10, wherein the contact protrusions of the support portion is positioned symmetrically with the contact protrusions of the contact point portion, or at least one or all of the contact protrusions of the support portion are positioned to be misaligned with the contact protrusions of the contact point portion.

12. A cable assembly comprising:
a planar cable that is provided so as to surround an outer surface of a conductor by an insulator and is divided into one surface and the other surface; and
a cable connector that has a plurality of contact protrusions electrically connected to the exposed conductor of the cable,
wherein the plurality of contact protrusions comprise three or more contact protrusions which are spaced apart from each other, and contact protrusions positioned at outside are shorter than at least one of contact protrusions positioned at inside.

13. The cable assembly of claim 12, wherein the cable includes:
a first terminal portion that is formed by at least a portion of the conductor being exposed to the one surface; and
a second terminal portion that is extended from the first terminal portion and is formed by at least a portion of the conductor being exposed to the other surface, and
wherein the connector includes:
one or more contact protrusions that come into contact with the first terminal portion; and
one or more contact protrusions that come into contact with the second terminal portion.

14. The cable assembly of claim 13, wherein the cable further includes a plate-shaped supplementary plate between the first terminal portion and the second terminal portion.

15. The cable assembly of claim 13, wherein the contact protrusions coming into contact with the first terminal portion is positioned symmetrically with the contact protrusions coming into contact with the second terminal portion, or at least one or all of the contact protrusions coming into contact with the first terminal portion are positioned to be misaligned with the contact protrusions coming into contact with the second terminal portion.
